(19) United States
(12) Patent Application Publication
(10) Pub. No.: US 2018/0266535 A1
(43) Pub. Date: Sep. 20, 2018

(54) Transmission and Method for Adjusting the Circumferential Backlash of the Transmission

(71) Applicant: Lenze Drives GmbH, Extertal (DE)

(72) Inventors: Horst UHLENBROK, Extertal (DE); Mirko HASCHKE, Extertal (DE)

(21) Appl. No.: 15/544,350

(22) PCT Filed: Jan. 11, 2016
(86) PCT No.: PCT/EP2016/050348

§ 371 Date: Jul. 18, 2017

(30) Foreign Application Priority Data
Jan. 19, 2015 (DE) 10 2015 200 741.3

(51) Int. Cl. F16H 57/022; F16H 1/14; F16H 57/038; F16H 57/12; F16C 23/08

(52) U.S. Cl. CPC F16H 57/022; F16H 1/14; F16H 57/038; F16H 2057/0225; F16C 23/08; F16H 2057/0221; F16H 57/12

(57) ABSTRACT

A transmission has a housing, and a first and a second shaft, each of which has a bevel gearwheel. The two bevel gearwheels are in meshing engagement with one another. The first shaft with a first bevel gearwheel is designed as an axially adjustable shaft and, for this purpose, is supported by two rolling bearings on both sides of the bevel gearwheel, wherein each of the rolling bearings has a shaft-side inner ring and a housing-side outer ring. The shaft-side inner rings are provided in a defined axial position on the first shaft, while the housing-side outer rings of the rolling bearings are guided on respective housing-side support surfaces and are restricted from moving toward one another solely by the inner rings and the shaft. The axial position of the housing-side outer rings of the rolling bearings can be adjusted on the side facing away from the bevel gearwheel by respective adjusting devices. Each of the adjusting devices has an adjusting element with an external thread on the side of the respective outer ring facing away from the bevel gearwheel. The external thread is inserted into an internal thread in the housing. The internal thread and the external thread are designed as fine threads, preferably with a pitch of at most 0.75 mm.

### BACKGROUND AND SUMMARY OF THE INVENTION

The invention relates to a transmission having two intermeshing bevel gearwheels.

Transmissions of this kind are used for many applications in mechanical engineering. By means of the two bevel gearwheels, a torque is transmitted from a shaft to a second shaft that is not parallel with the first.

In such transmissions, there is usually a desire on a case-by-case basis to adjust the circumferential backlash, i.e. the ability of one of the shafts to rotate when a second shaft is not rotating and/or to adjust the axial play or the axial preload on a shaft. It is necessary here to be able to adjust these parameters with as few problems as possible, even after the assembly of the transmission.

The conventional method hitherto in this context envisages making one of the shafts axially movable. This is generally accomplished by providing spacing washers, by means of which the outer ring is supported on a retaining ring secured axially on the housing, to the outside of the respective outer rings of the rolling bearings by which this shaft is supported. Through the selection and the number and type of spacing washers to be used, the outer ring of the respective rolling bearing can be adjusted relative to the axial position of the retaining ring. On a case-by-case basis, it is also possible in this context to use a plurality of spacing washers, which together ensure the desired position in the axial direction.

The conventional practice here is to insert or not insert shims in a mutually corresponding manner on two rolling bearings, usually disposed in an X arrangement, thereby in each case achieving a defined position relative to the retaining rings.

The procedure described is relatively complex. To adapt a transmission, the retaining ring must be removed, and the chosen spacing washers, which together have the desired thickness, must be inserted and the retaining ring reinserted.

Apart from the complexity of assembly and the sometimes only unsatisfactory choice of spacing washers available, it has also been found disadvantageous that the spacing washers settle during operation and, as a result, no longer maintain the position, set by means of said washers, hence the preset specification of the outer ring of the respective bearing.

It is the object of the invention to develop a transmission of the type in question in such a way that it allows simple adjustment of the position of one of the bevel wheels in the axial direction.

According to the invention, this object is achieved by a transmission having the following features:
a. the transmission has a housing, and
b. the transmission has a first and a second shaft, each of which has a bevel gearwheel, and
c. the two bevel gearwheels are in meshing engagement with one another, and
d. the first shaft with a first bevel gearwheel is designed as an axially adjustable shaft and, for this purpose, is supported by two rolling bearings on both sides of the bevel gearwheel,
e. each of the rolling bearings has a shaft-side inner ring and a housing-side outer ring,
f. the shaft-side inner rings are provided in a defined axial position on the first shaft, and
g. the housing-side outer rings of the rolling bearings are guided on respective housing-side support surfaces and are restricted from moving toward one another solely by the inner rings and the shaft, and
h. the axial position of the housing-side outer rings of the rolling bearings can be adjusted on the side facing away from the bevel gearwheel by respective adjusting devices, characterized by the features:
i. each of the adjusting devices has an adjusting element with an external thread on the side of the respective outer ring facing away from the bevel gearwheel, said external thread being inserted into an internal thread in the housing, and
j. the internal thread and the external thread are designed as fine threads, preferably with a pitch of at most 3 mm, in particular preferably of at most 1.5 mm or at most 0.75 mm.

A transmission according to the invention has a housing, within which the two bevel gearwheels are arranged. This first and second bevel gearwheel are each secured for conjoint rotation and in an axially defined position on a first and second shaft, respectively, and are in meshing engagement with one another.

The first shaft with the first bevel gearwheel is of axially adjustable design. This adjustment is accomplished by means of two rolling bearings, by means of which the first shaft is supported on the housing.

The inner rings of the two rolling bearings, which are preferably rolling bearings in a preloaded support arrangement, in particular taper rolling bearings in an X arrangement, are in an axially defined position on the first shaft. For this purpose, shoulders, on which the respective inner rings rest, are preferably provided in the first shaft.

The outer rings of the rolling bearings are supported radially on an inward-facing supporting surface of the housing. In this arrangement, they are not limited in terms of movement on the supporting surface and in a direction toward one another. Only on the outside of the respective outer rings are adjusting devices provided to enable the axial position of the respective outer rings to be adjusted. Together, therefore, it is only these adjusting devices arranged axially on the outside which allow the axial movement of the first shaft and, with it, of the first bevel gearwheel.

For this purpose, the adjusting devices each have an adjusting element, which has an external thread, by means of which the adjusting element is screwed into an internal thread in the housing. The adjusting element rests directly or via an intermediate element, the latter preferably being rigid in the axial direction, on the outer ring of the respective rolling bearing, thereby defining the axial position thereof.

The external thread and the internal thread are designed as fine threads. As a result, the adjusting elements can be adjusted very precisely in terms of the axial position thereof. The pitch of the threads, i.e. the distance in the axial direction which is achieved by a complete 360° rotation of an adjusting element relative to the housing, is preferably at most 3 mm, preferably at most 1.5 mm, in particular preferably at most 0.75 mm. The possibility of even finer adjustment is available if the pitch is at most 0.5 mm, in particular preferably 0.35 mm.

The adjusting element is preferably screwed into the housing from the outside, thus allowing adjustment even when the transmission is assembled.

Thus, in particular, it is possible to adjust the circumferential backlash of the bevel gearwheels by rotating the two adjusting devices on the two rolling bearings of the first shaft jointly to the same extent and in the same direction. The two outer rings of the rolling bearings are thereby moved axially in common, while the preload on the shaft remains the same, until the desired circumferential backlash is achieved.

The adjusting elements can be designed as closed covers which completely close the space accommodating the shafts and the bevel wheels. However, it may also be desired to design the first shaft directly as an input or output shaft and, for this purpose, to pass it out of the housing. In such a case, at least one of the adjusting elements preferably has a through opening for passing through the first shaft.

Both in the case of a closed cover and in the case of an adjusting element having a through opening of this kind, it can be advantageous if a seal is provided between the adjusting element and the inward-facing housing wall. In the case where the adjusting element is designed with a through opening, it is regarded as advantageous if an encircling shaft seal is arranged in the through opening.

To enable the adjusting elements to be rotated in a controlled manner in the thread and thereby enable the axial position to be adjusted, this preferably has a noncircular handling region. That is to say, surfaces on which a torque can be applied by positive engagement are provided on the side of the adjusting element which faces outward, away from the rolling bearing. An embodiment in which the adjusting element is provided with an external or internal square or hexagonal profile is particularly advantageous here.

There are a number of possibilities for enabling the adjusting elements to be secured in the axial position set. In an advantageous embodiment, a counter element is provided in addition to the adjusting element, said counter element likewise having an external fine thread and being screwed into the internal thread in the housing. It is thereby possible to brace the composite structure comprising the adjusting element and the counter element in the screwed-in state.

Since the adjustment of the adjusting elements is usually a one-off process, the use of an adhesive joint can also be expedient. In this case, the adjusting element and the housing are joined to one another in the region of the thread or adjacent thereto by means of the adhesive, thus preventing a rotary relative motion and thus axial adjustment of the adjusting element.

An adhesive joint of this kind simultaneously serves to provide effective sealing between the housing and the adjusting element. Instead or, alternatively, in addition, however, it is also possible for a seal, e.g. an O-ring, to be arranged between the housing and the adjusting element.

Apart from this, there are also other ways of securing against rotation, e.g. by means of a radial grub screw or by means of plastic deformations, e.g. by means of punch marks.

Fundamentally, it is considered preferable if both the adjusting elements act directly on the outer rings of the two rolling bearings, thus ensuring that the adjusting devices and the rolling bearings always remain fixed in position relative to one another in the axial direction. This is achieved by direct contact between the respective outer ring of the rolling bearing and the adjusting element or by providing a rigid and axially incompressible intermediate element between the adjusting element and the outer ring.

However, it is also possible to conceive of an embodiment in which only one of the rolling bearings ensures such fixity in position, while a spring device, comprising a diaphragm spring for example, is provided between the adjusting element and the outer ring in the case of the second rolling bearing. With an embodiment of this kind, the bearing with the spring device is preferably the rolling bearing further away from the bevel gearwheel or the rolling bearing provided on the tapered side of the bevel wheel. To a limited extent, therefore, the adjustment of the circumferential backlash can be brought about simply by rotating one adjusting element while simultaneously changing the preload.

### BRIEF DESCRIPTION OF THE DRAWINGS

The invention is described below by means of an illustrative embodiment, which is shown in the figures.

FIG. 1 shows a transmission according to the invention.

FIGS. 2 and 3 show, on an enlarged scale, partial areas of the transmission shown in FIG. 1 that are essential to the invention.

FIG. 4 shows an adjusting element of the transmission shown in FIGS. 1 to 3, in perspective.

FIG. 5 shows an alternative adjusting element in perspective.

### DETAILED DESCRIPTION OF THE EXEMPLARY EMBODIMENTS

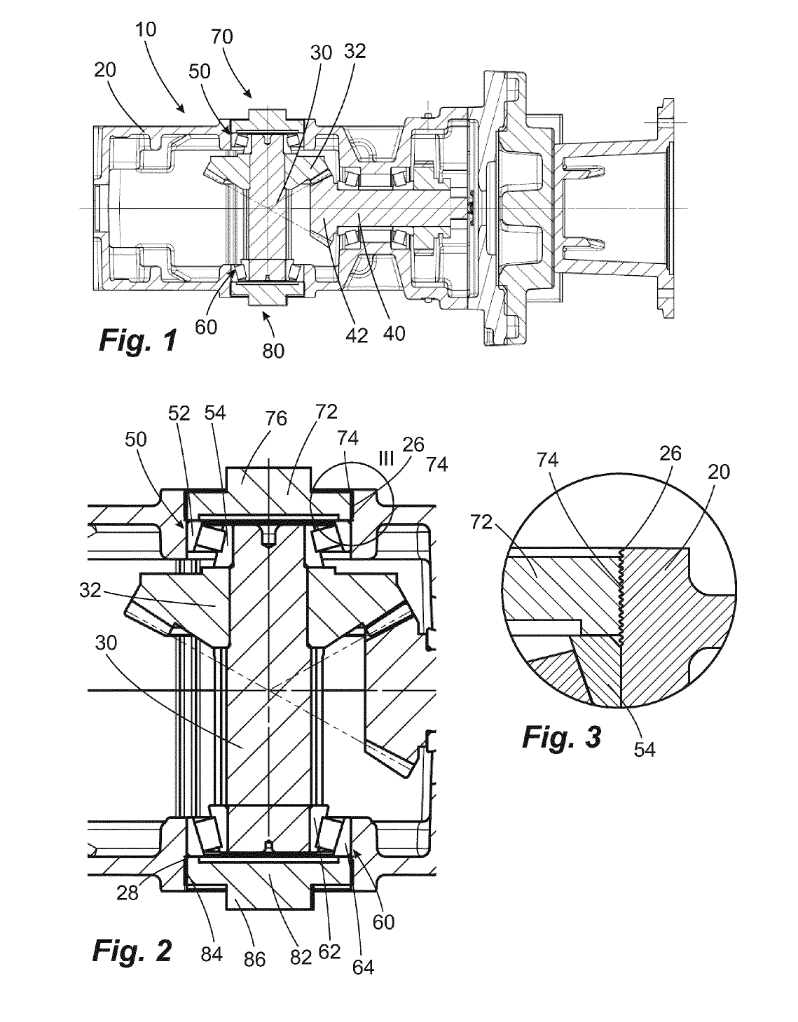

FIG. 1 shows a transmission 10 according to the invention, which is distinguished by two intermeshing bevel gearwheels 32, 42. FIGS. 2 and 3 show details of this transmission on an enlarged scale.

The transmission 10 has a housing 20, wherein all those sections of the transmission 10 which are fixed in location relative to one another after assembly are regarded as part of the housing. The housing 20 defines a housing interior, within which two nonparallel shafts 30, 40 are supported. The two intermeshing bevel gearwheels 32, 42 are secured on these shafts 30, 40.

In order to be able to adjust the circumferential backlash of the bevel gearwheels 32, 42 in accordance with the area of application, the first shaft 30 can be moved axially by means of adjusting devices 70, 80. The mode of operation of these adjusting devices 70, 80 is explained below.

The first shaft 30 is supported by means of two rolling bearings 50, 60, which are each designed as taper roller bearings and which are arranged in a preloaded X support arrangement.

The inner rings 52, 62 of these rolling bearings 50, 60 are slipped onto the first shaft 30 and each rest against shoulders on the shaft 30, with the result that the position thereof relative to one another and to the bevel gearwheel 32 in the axial direction is predetermined.

The outer rings 54, 64 of the rolling bearings 50, 60 rest on cylindrical supporting surfaces 22, 24 of the housing 20. The movement thereof toward one another is limited only by the rolling elements, the inner rings 52, 62 and the shaft 30. No stops are provided on the inside of the housing. The outward movement of the outer rings 54, 64 is limited by the adjusting devices 70, 80.

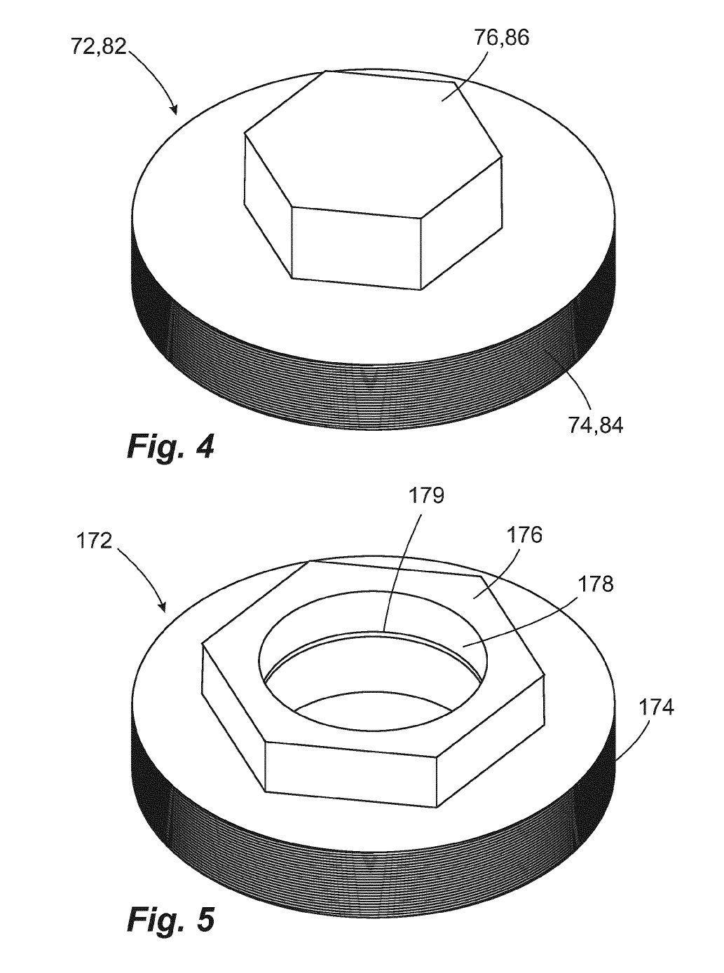

Each of the adjusting devices 70, 80 has an adjusting element 72, 82, which can be removed in the perspective view in FIG. 4.

The adjusting elements 72, 82 form covers with an external thread 74, 84, which are screwed into internal threads 26, 28 in the housing on opposite sides of the housing 20, at both ends of the shaft 30. In an outer edge region, the adjusting elements each press on the outer rings 54, 64 of the rolling bearings 50, 60, with the result that the outward movement thereof is limited and the rolling bearings can be braced against one another via the shaft 30.

On the outside thereof, the adjusting elements 72, 82 each have a handling region in the form of an external hexagonal profile 76, 86, thus allowing them to be rotated and thereby axially adjusted by means of generally available tools.

Assembly is preferably performed in such a way that, after the shaft 30 and the rolling bearings 50, 60 have been arranged in the housing, a first adjusting element 72, 82 is first of all screwed in. The other, opposite adjusting element is then screwed in, wherein a torque wrench can be used, thus ensuring that a defined prestress in the shaft 30 is achieved via the rolling bearings 50, 60.

Once this has been completed, the adjustment of the circumferential backlash can then take place by rotating the two adjusting elements 72, 82, preferably simultaneously and to the same extent. As a result, one of the adjusting elements presses axially on the outer ring of the rolling bearing associated therewith and moves the latter together with the shaft 30, while the other adjusting element simultaneously creates the axial space required for this movement. Since the threads 26, 28, 74, 84 are designed as fine threads, this adjustment can be performed in a very precise and controlled manner. The preset stress in the shaft 30 remains unchanged owing to the axially identical movement of the adjusting elements 72, 82.

Once the desired circumferential backlash has been achieved, the adjusting elements 72, 82 are preferably secured finally against rotation. This can be accomplished by adhesive bonding or, alternatively, by means of a counter element.

FIG. 5 shows an alternative embodiment of an adjusting element 172. This has a through opening 178, through which the shaft 30 can be passed out of the housing 20 of the transmission 10. Thus, this shaft can be used directly as an input or output shaft. An inward-oriented shaft seal 179 can be arranged in the through opening.

1-11. (canceled)

12. A transmission, comprising:
a. a housing;
b. a first and a second shaft, each of which has a bevel gearwheel,
c. the two bevel gearwheels are in meshing engagement with one another,
d. the first shaft with a first bevel gearwheel is designed as an axially adjustable shaft and, for this purpose, is supported by two rolling bearings on both sides of the bevel gearwheel,
e. each of the rolling bearings has a shaft-side inner ring and a housing-side outer ring,
f. the shaft-side inner rings are provided in a defined axial position on the first shaft,
g. the housing-side outer rings of the rolling bearings are guided on respective housing-side support surfaces and are restricted from moving toward one another solely by the inner rings and the shaft, and
h. the axial position of the housing-side outer rings of the rolling bearings are adjustable on the side facing away from the bevel gearwheel by respective adjusting devices, wherein
i. each of the adjusting devices has an adjusting element with an external thread on the side of the respective outer ring facing away from the bevel gearwheel, said external thread being inserted into an internal thread in the housing, and
j. the internal thread and the external thread are designed as fine threads, preferably with a pitch of at most 3 mm.

13. The transmission as claimed in claim 12, wherein the pitch is at most 1.5 mm.

14. The transmission as claimed in claim 12, wherein the pitch is at most 0.75 mm.

15. The transmission as claimed in claim 12, wherein:
a. at least one of the adjusting elements is designed as a closed cover.

16. The transmission as claimed in claim 12, wherein:
a. at least one of the adjusting elements has a through opening for the passage of the first shaft.

17. The transmission as claimed in claim 16, wherein:
b. the through opening is designed with a shaft seal for contact with the first shaft.

18. The transmission as claimed in claim 12, wherein:
a. the adjusting elements are accessible from outside the housing with the transmission assembled.

19. The transmission as claimed in claim 12, wherein:
a. at least one of the adjusting elements has a noncircular handling region for introducing an adjusting torque.

20. The transmission as claimed in claim 19, wherein:
a. the noncircular handling region has at least two mutually paralleled torque introduction surfaces with either an internal or external hexagonal profile or with an internal or external square profile.

21. The transmission as claimed in claim 12, wherein:
a. a counter element having an external thread for locking against the adjusting element is provided on the side of at least one of the adjusting elements facing away from the bevel gearwheel, or
b. at least one of the adjusting elements is fixed in position relative to the housing by an adhesive joint, or
c. a seal, in the form of an O-ring or other encircling sealing element composed of elastically deformable material, is provided between at least one of the adjusting elements and the housing.

22. The transmission as claimed in claim 12, wherein:
a. an axially acting spring device is provided between one of the adjusting elements and the associated outer ring of the rolling bearing.

23. The transmission as claimed in claim 12, wherein:
a. the two rolling bearings form a preloaded support arrangement, in an X arrangement.

24. The transmission as claimed in claim 12, wherein:
a. the rolling bearings are taper roller bearings.

25. The transmission as claimed in claim 12, wherein:
a. the internal thread and the external thread are designed as fine threads with a pitch of at most 0.5 mm.

26. The transmission as claimed in claim 12, wherein:
a. the internal thread and the external thread are designed as fine threads with a pitch of at most 0.35 mm.

27. A method for adjusting the circumferential backlash of a transmission as claimed in claim 12, the method comprising the steps of:
a. fixing the shaft axially in position by screwing in the two adjusting elements, and
b. rotating synchronously the adjusting elements in order to move the shaft axially via the threads while keeping a preload on the shaft constant.
